(19) United States
(12) Patent Application Publication
(10) Pub. No.: US 2016/0194979 A1
(43) Pub. Date: Jul. 7, 2016

(54) CANTED BOAS INTERSEGMENT GEOMETRY

(71) Applicant: UNITED TECHNOLOGIES CORPORATION, Hartford, CT (US)

(72) Inventor: Ken F. Blaney, Middleton, NH (US)

(21) Appl. No.: 14/911,123

(22) PCT Filed: Aug. 25, 2014
(86) PCT No.: PCT/US2014/052466

§ 371 Date: Feb. 9, 2016

Related U.S. Application Data
(60) Provisional application No. 61/874,593, filed on Sep. 6, 2013.

(51) Int. Cl. F01D 25/12; F01D 5/12; F01D 11/08; F01D 5/02

(52) U.S. Cl. CPC F01D 25/12; F01D 5/02; F01D 5/12; F01D 11/08; F05D 2220/32; F05D 2240/55; F05D 2260/20

(57) ABSTRACT

A blade outer air seal segment has an inner surface and an outer surface. The outer surface is in communication with a cooling air source. The segment also has a first end having a first surface extending from the inner surface and a first angled surface extending from the first surface, and a second end having a second surface extending from the inner surface and a second angled surface extending from the second surface.

### CROSS-REFERENCE TO RELATED APPLICATION(S)

This application claims the benefit of PCT application PCT/US2014/052466, filed Aug. 25, 2014, for “CANTED BOAS INTERSEGMENT GEOMETRY”, by Ken F. Blaney, and U.S. Provisional Application No. 61/874,593, filed Sep. 6, 2013, for “CANTED BOAS INTERSEGMENT GEOMETRY”, by Ken F. Blaney.

### STATEMENT OF GOVERNMENT INTEREST

This invention was made with government support under FA8650-09-D-2923 0021 awarded by the Air Force. The government has certain rights in the invention.

### BACKGROUND

The present disclosure relates to gas turbine engines, and more specifically to blade outer air seals of turbine sections of gas turbine engines.

Gas turbine engines include turbine blades configured to rotate and extract energy from hot combustion gases that are communicated through the gas turbine engine. An outer casing of an engine static structure of the gas turbine engine may include one or more blade outer air seals (BOAS) that provide an outer radial flow path boundary.

Existing BOAS architectures experience rotor disturbances that displace intersegment cooling air. As a result, the cooling air usage is not as efficient as it could be.

### SUMMARY

A blade outer air seal segment has an inner surface and an outer surface. The outer surface is in communication with a cooling air source. The segment also has a first end having a first surface extending from the inner surface and a first angled surface extending from the first surface, and a second end having a second surface extending from the inner surface and a second angled surface extending from the second surface.

Similarly, a gas turbine engine includes a turbine section with a plurality of turbine blades in a flow path that rotate in a direction and a blade outer air seal. The blade outer air seal has a plurality of arcuate seal segments extending circumferentially about the flow path. Each segment is spaced radially from the turbine blades. Each segment also includes an inner surface and an outer surface. The outer surface is in communication with a cooling air source. Further, each segment has a first end having a first planar surface perpendicular to the inner surface and a first canted surface extending from the first planar surface, and a second end having a second planar surface perpendicular to the inner surface and a second canted surface extending from the second planar surface. The first canted surface and the second canted surface are angled in the direction opposite of the rotation of the turbine blades.

### BRIEF DESCRIPTION OF THE DRAWINGS

FIG. 1 is a partial cross-sectional view of a gas turbine engine.

FIG. 2 is a cross-sectional view of a portion of the turbine section of a gas turbine engine.

FIG. 3 is a perspective view of a blade outer air seal (BOAS).

FIG. 4 is a cross-sectional view of the BOAS.

FIG. 5A is a side elevation view of the connection between two adjacent BOAS segments.

FIG. 5B is a side elevation view of the connection between two adjacent BOAS segments.

FIG. 6 is a plan bottom plan view of two adjacent BOAS segments.

### DETAILED DESCRIPTION

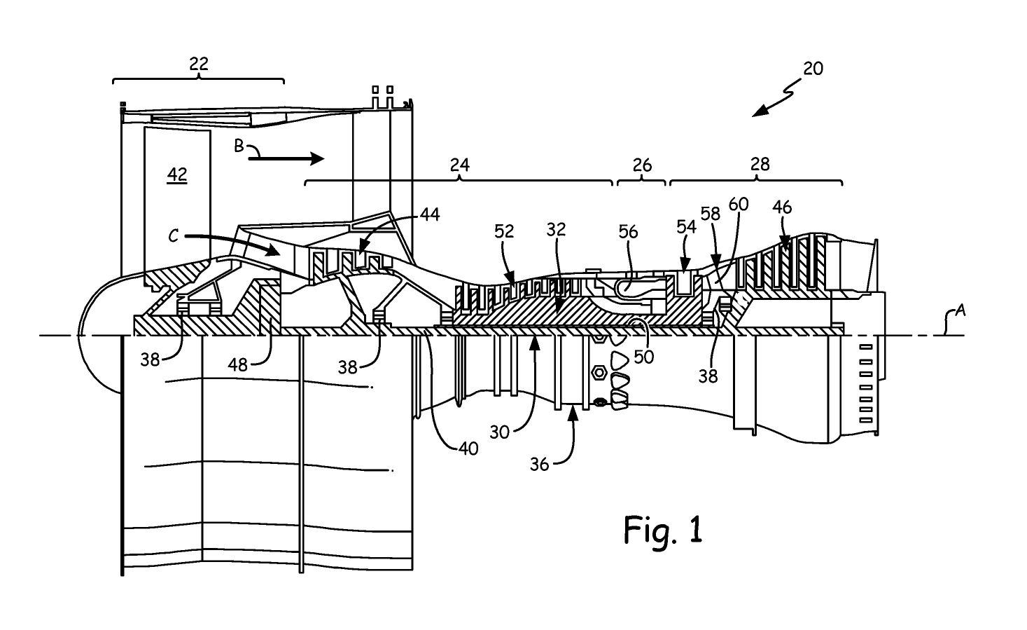

The present disclosure is described with reference to several figures, in each of which like parts are identified and referenced with like numerals and characters. FIG. 1 is a quarter-sectional view that schematically illustrates example gas turbine engine 20 that includes fan section 22, compressor section 24, combustor section 26 and turbine section 28. Alternative engines might include an augmenter section (not shown) among other systems or features. Fan section 22 drives air along bypass flow path B while compressor section 24 draws air in along core flow path C where air is compressed and communicated to combustor section 26. In combustor section 26, air is mixed with fuel and ignited to generate a high pressure exhaust gas stream that expands through turbine section 28 where energy is extracted and utilized to drive fan section 22 and compressor section 24.

Although the disclosed non-limiting embodiment depicts a turbofan gas turbine engine, it should be understood that the concepts described herein are not limited to use with turbofans as the teachings may be applied to other types of turbine engines; for example, an industrial gas turbine; a reverse-flow gas turbine engine; and a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes low speed spool 30 and high speed spool 32 mounted for rotation about engine central longitudinal axis A relative to engine static structure 36 via several bearing systems 38. It should be understood that various bearing systems 38 at various locations may alternatively or additionally be provided.

Low speed spool 30 generally includes inner shaft 40 that connects fan 42 and low pressure (or first) compressor section 44 to low pressure (or first) turbine section 46. Inner shaft 40 drives fan 42 through a speed change device, such as geared architecture 48, to drive fan 42 at a lower speed than low speed spool 30. High-speed spool 32 includes outer shaft 50 that interconnects high pressure (or second) compressor section 52 and high pressure (or second) turbine section 54. Inner shaft 40 and outer shaft 50 are concentric and rotate via bearing systems 38 about engine central longitudinal axis A.

Combustor 56 is arranged between high pressure compressor 52 and high pressure turbine 54. In one example, high pressure turbine 54 includes at least two stages to provide double stage high pressure turbine 54. In another example, high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of low pressure turbine 46 as related to the pressure measured at the outlet of low pressure turbine 46 prior to an exhaust nozzle.

Mid-turbine frame 58 of engine static structure 36 can be arranged generally between high pressure turbine 54 and low pressure turbine 46. Mid-turbine frame 58 further supports bearing systems 38 in turbine section 28 as well as setting airflow entering the low pressure turbine 46.

The core airflow C is compressed first by low pressure compressor 44 and then by high pressure compressor 52 mixed with fuel and ignited in combustor 56 to produce high speed exhaust gases that are then expanded through high pressure turbine 54 and low pressure turbine 46. Mid-turbine frame 58 includes vanes 60, which are in the core airflow path and function as an inlet guide vane for low pressure turbine 46. Utilizing vane 60 of mid-turbine frame 58 as the inlet guide vane for low pressure turbine 46 decreases the axial length of the low pressure turbine 46 without increasing the axial length of mid-turbine frame 58. Reducing or eliminating the number of vanes in low pressure turbine 46 shortens the axial length of turbine section 28. Thus, the compactness of gas turbine engine 20 is increased and a higher power density may be achieved.

The disclosed gas turbine engine 20 in one example is a high-bypass geared aircraft engine. In a further example, gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, gas turbine engine 20 includes a bypass ratio greater than about ten (10:1) and the fan diameter is significantly larger than an outer diameter of low pressure compressor 44. It should be understood, however, that the above parameters are only exemplary of one embodiment of a gas turbine engine including a geared architecture and that the present disclosure is applicable to other gas turbine engines.

A significant amount of thrust is provided by bypass flow B due to the high bypass ratio. Fan section 22 of engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tᵣₐₘ ° R)/518.7)^{0.5}]. The “Low corrected fan tip speed”, as disclosed herein according to one non-limiting embodiment, is less than about 1150 ft/second.

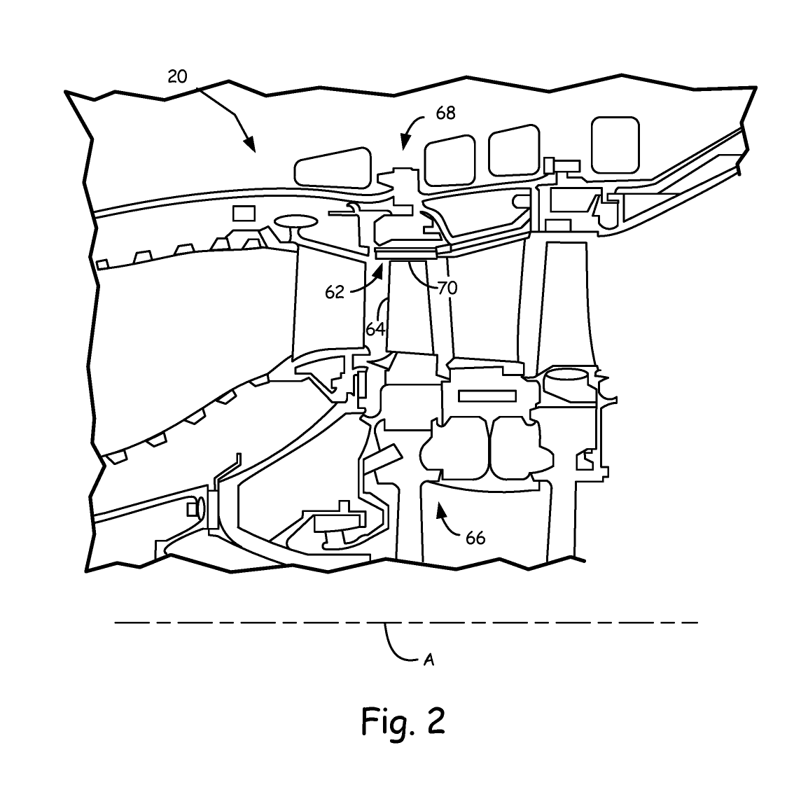

Referring to FIG. 2, a section of gas turbine engine 20 includes blade outer air seal 62 (hereinafter “BOAS”) disposed between a plurality of circumferentially disposed rotor blades 64 of rotor stage 66 and annular outer engine case 68. In one embodiment, BOAS 62 includes a plurality of circumferentially extending segments, and is adapted to limit air leakage between blade tips 70 and engine case 68. The segments of BOAS 62 are evenly spaced about an engine centerline at axis A.

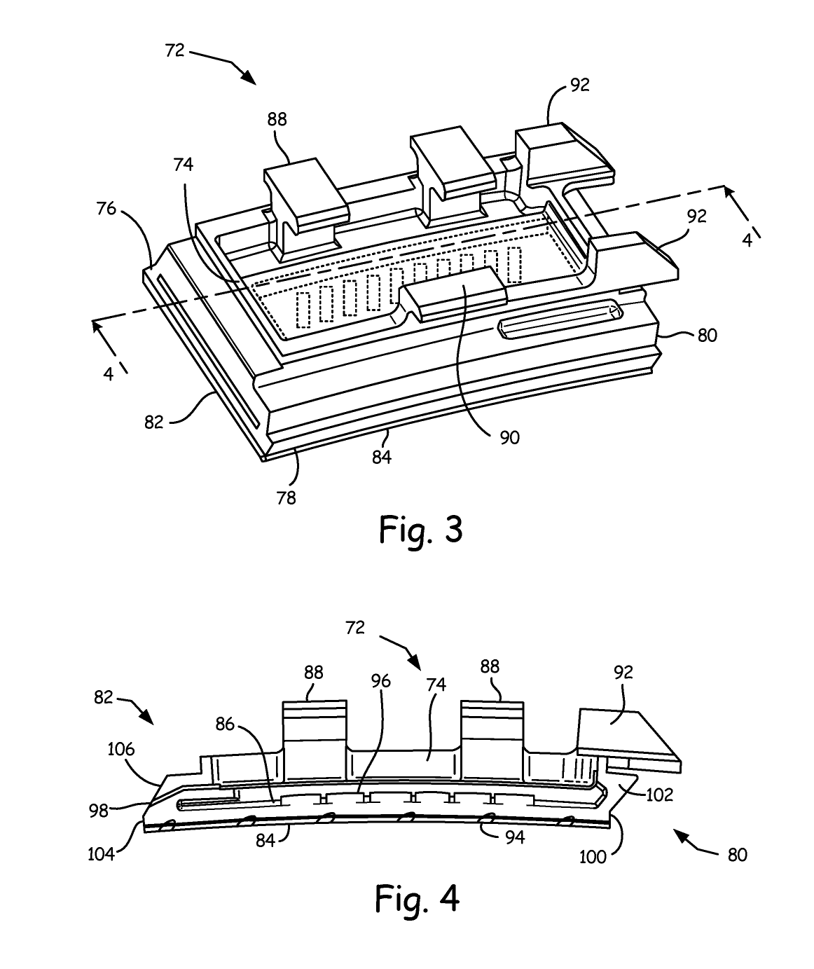

A circumferential ring array of a plurality of segments 72 (see FIG. 3) may encircle an associated blade rotor stage 66 of gas turbine engine 10 to form BOAS 62. The assembled inner diameter faces of segments 72 locally bound an outboard extreme of the core flow path for gases exiting the combustor.

BOAS 62 is air-cooled. Bleed air from engine 20 may be directed to a chamber immediately outboard of the BOAS 62. The bleed air may be directed through ports that create internal cooling passageway network in BOAS 62 (see e.g., cooling holes 94 and cooling channel 98 of FIG. 4). The exemplary network includes a plurality of passages from the interior chamber of BOAS 62 to the plurality of outlets.

FIG. 3 is a perspective view of one BOAS segment 72. Segment 72 has a main body portion 74 having leading/upstream/forward end 78 and trailing/downstream/aft end 76. Segment 72 also has first and second circumferential ends or mate faces 80 and 82. The body has an inner diameter surface 84 and an outer diameter surface 86. To mount BOAS segment 72 to outer case 68 structure of gas turbine engine 20 (FIG. 2), segment 72 has a plurality of mounting hooks including aft mounting hooks 88 having a rearward projecting distal portion recessed aft of the aft end 76, and forward hooks 90 having a forwardly projecting portion recessed forward of forward end 78. First mate face 80 has two radial standoffs 92 attached thereto.

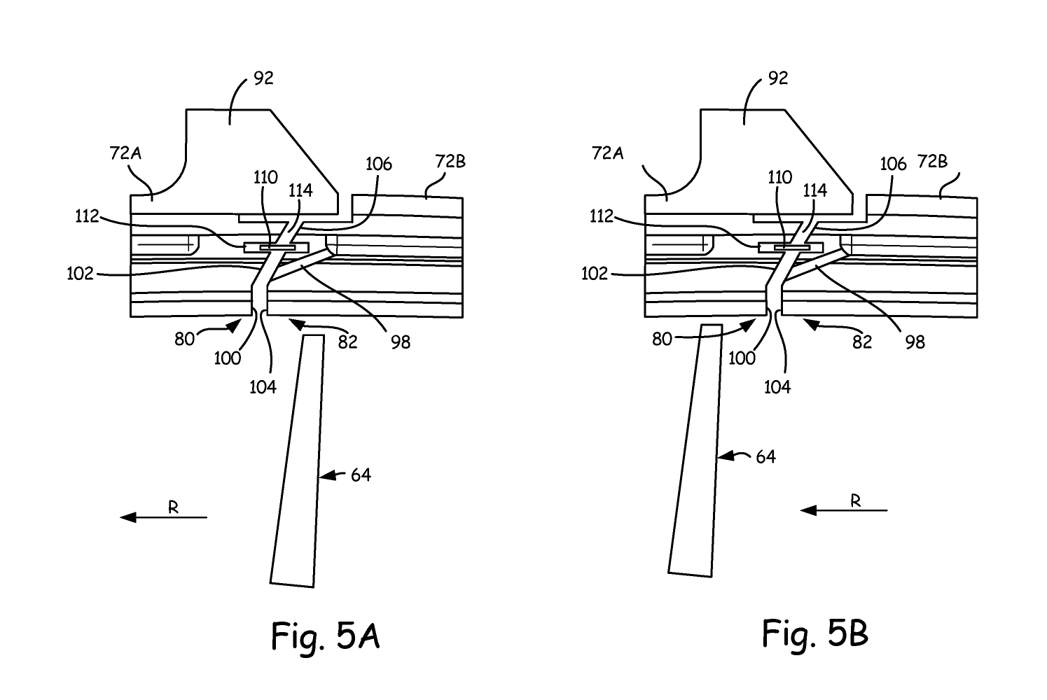

FIG. 4 is a cross-sectional view of BOAS segment 72 with mate faces 80 and 82, inner surface 84, and outer surface 86. Forward mounting hook 90 and radial standoff 92 are also visible. A plurality of cooling holes 94 may be present, and will extend from inner surface 84 to outer surface 86. Cooling air, such as bleed air previously described, flows through optional cooing holes 94 to moderate the temperature of engine components. Similarly, a cooling channel 98 extends from outer surface 86 to second mate face 82 to provide cooling of mate face 82 and mate face 80 of an adjacent segment (See FIG. 5). Outer surface 86 may contain a series of projections or turbulators 96 to promote the desired flow and cooling of the bleed air. Inner surface 84 may also be a planar surface without any cooling features present.

Mate face 80 contains two parts: radial edge 100 and angled edge 102. Radial edge 100 is generally perpendicular to and extends from inner surface 84. Angled edge 102 is canted and extends from radial edge 100. Similarly, mate face 82 contains radial edge 104 and angled edge 106. Radial standoff 92 extends past the termination of angled edge 102.

FIG. 5A and 5B are side elevation views of the connection between two adjacent BOAS segments. Two adjacent segments 72A and 72B are shown about rotor blade 64 rotating in direction R. Radial edge 100 on mate face 80 of segment 72A is nested next to radial edge 104 on mate face 82 of segment 72B. Similarly, angled edge 102 on mate face 80 of segment 72A is adjacent angled edge 106 on mate face 82 of segment 72B. Radial standoff 92 extends past angled edge 102 on mate face 80, and a portion overlaps and is located over mate face 82.

In FIG. 5A, rotor blade 64 is forward of the intersection of mate faces 80 and 82 of segments 72A and 72B, respectively. In this position, a localized region of low pressure will be on the forward side of rotor blade 64, below the intersection of segments 72A and 72B. In FIG. 5B, a localized region of high pressure is present below the intersection of segment 72A and 72B. Prior art designs allow cooling air to be easily pushed into the intersegment gap during exposure to high pressure and sucked out during exposure to low pressure, thus decreasing the effectiveness thereof. Due to the placement of the exit of channel 98 on angled surface 106, high pressure hot gas ingestion into the intersection is minimized. The exit of channel 98 on mateface 80 is protected due to the angled geometry. To further prevent the ingestion of hot gas, feather seal 110 may be present between slots 112 and 114 of mate faces 80 and 82, respectively. Cooling is only provided through cooling channel 98 on the blade departure side (mate face 80) of segment 72. All intersegment cooling air is moving in the same direction, which improves performance. The aforementioned segment geometry is less expensive to manufacture as cooling features are only present on one mate face. Although illustrated as a single channel in the embodiment illustrated, multiple cooling channels may exist.

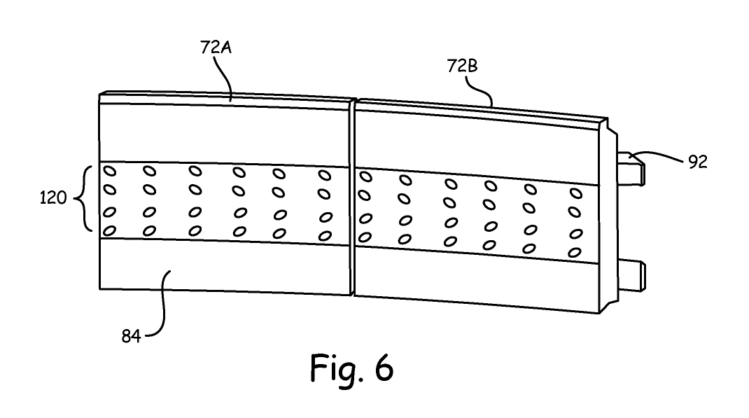

FIG. 6 is a plan bottom plan view of two adjacent segments 72A and 72B. A plurality of cooling apertures 120 is present on inner surface 84 of each segment 72A and 72B. In prior art designs, a non-uniform cooling pattern is used to compensate for cooling loses associated with typical mate face geometries. With the current design described herein, a uniform pattern may be used for the plurality of cooling apertures 120.

The intersegment geometry described herein helps minimize the turbine rotor effect on cooling airflow, thus resulting in more efficient use of intersegment cooling air from channel 98. The angled mate faces, along with the resulting intersegment overlaps, allow for thinner walls between inner surface 84 and outer surface 86 without compromising containment capability of each segment 72. Depending on the angle utilized for the angled portions of the mate faces, core access may be improved over comparable conventional shiplap configurations. The angled sidewalls also minimize or eliminate cooling hole back strikes during the manufacture of segment 72. The uniform cooling hole pattern across the entire BOAS is not presently available with the conventional designs. In addition, the angled sidewalls assist in the protection of feather seal 110.

### Discussion of Possible Embodiments

The following are non-exclusive descriptions of possible embodiments of the present invention.

A blade outer air seal segment has an inner surface and an outer surface. The outer surface is in communication with a cooling air source. The segment also has a first end having a first surface extending from the inner surface and a first angled surface extending from the first surface, and a second end having a second surface extending from the inner surface and a second angled surface extending from the second surface.

The blade outer air seal segment of the preceding paragraph can optionally include, additionally and/or alternatively, any one or more of the following features, configurations and/or additional components:

a cooling slot extending at least partially through the second end;

the cooling slot has an exit on the second angled surface;

a plurality of cooling holes that extend from the inner surface to the outer surface;

the cooling holes are arranged in a uniform pattern;

a radial standoff connected to the outer surface; and/or

the radial standoff protrudes beyond the first end.

A gas turbine engine includes a turbine section with a plurality of turbine blades in a flow path that rotate in a direction and a blade outer air seal. The blade outer air seal has a plurality of arcuate seal segments extending circumferentially about the flow path. Each segment is spaced radially from the turbine blades. Each segment also includes an inner surface and an outer surface. The outer surface is in communication with a cooling air source. Further, each segment has a first end having a first planar surface perpendicular to the inner surface and a first canted surface extending from the first planar surface, and a second end having a second planar surface perpendicular to the inner surface and a second canted surface extending from the second planar surface. The first canted surface and the second canted surface are angled in the direction opposite of the rotation of the turbine blades.

The gas turbine engine of the preceding paragraph can optionally include, additionally and/or alternatively, any one or more of the following features, configurations and/or additional components:

a cooling slot extending at least partially through the second end;

the cooling slot is located in the second canted surface of each respective segment;

the inner surface of each segment contains a plurality of cooling holes;

the plurality of cooling holes is arranged in a uniform pattern;

a radial standoff connected to the outer surface;

the radial standoff protrudes beyond the first end of a first segment and overhangs the second end of an adjacent second segment; and/or

a feather seal extending between the first end of a first segment and the second end of an adjacent second segment.

Although the present invention has been described with reference to preferred embodiments, workers skilled in the art will recognize that changes may be made in form and detail without departing from the spirit and scope of the invention. For example, any core configuration may be utilized with the previously described geometry, including impingement, refractory metal core (RMC), ceramic shell casting (CSC), and the like.

1. A blade outer air seal segment comprising:
an inner surface and an outer surface, the outer surface in communication with a cooling air source;
a first end having a first surface extending from the inner surface and a first angled surface extending from the first surface; and
a second end having a second surface extending from the inner surface and a second angled surface extending from the second surface.

2. The blade outer air seal segment of claim 1 further comprising:
a cooling slot extending at least partially through the second end.

3. The blade outer air seal segment of claim 2 wherein the cooling slot has an exit on the second angled surface.

4. The blade outer air seal segment of claim 1 wherein a plurality of cooling holes extend from the inner surface to the outer surface.

5. The blade outer air seal segment of claim 4 wherein of cooling holes are arranged in a uniform pattern.

6. The blade outer air seal segment of claim 1 further comprising:
a radial standoff connected to the outer surface.

7. The blade outer air seal segment of claim 6 wherein the radial standoff protrudes beyond the first end.

8. A gas turbine engine comprising:
a turbine section including:
a plurality of turbine blades in a flow path that rotate in a direction; and
a blade outer air seal including:
a plurality of arcuate seal segments extending circumferentially about the flow path, each segment spaced radially from the turbine blades,
wherein said each segment includes:
an inner surface and an outer surface, the outer surface in communication with a cooling air source;
a first end having a first planar surface perpendicular to the inner surface and a first canted surface extending from the first planar surface; and
a second end having a second planar surface perpendicular to the inner surface and a second canted surface extending from the second planar surface;
wherein the first canted surface and the second canted surface are angled in the direction opposite of the rotation of the turbine blades.

9. The gas turbine engine of claim 8 wherein each segment further comprises:
a cooling slot extending at least partially through the second end.

10. The gas turbine engine of claim 9 wherein the cooling slot is located in the second canted surface of each respective segment.

11. The gas turbine engine of claim 8 wherein the inner surface of each segment contains a plurality of cooling holes.

12. The gas turbine engine of claim 11 wherein the plurality of cooling holes is arranged in a uniform pattern.

13. The gas turbine engine of claim 8 wherein each segment further comprises:
a radial standoff connected to the outer surface.

14. The gas turbine engine of claim 13 wherein the radial standoff protrudes beyond the first end of a first segment and overhangs the second end of an adjacent second segment.

15. The gas turbine engine of claim 8 further comprising:
a feather seal extending between the first end of a first segment and the second end of an adjacent second segment.
